(19) United States
(12) Patent Application Publication
(10) Pub. No.: US 2026/0358605 A1
(43) Pub. Date: Nov. 12, 2026

(54) ZOOM LENS AND IMAGING APPARATUS

(71) Applicant: Tamron Co., Ltd., Saitama (JP)

(72) Inventor: Takahiro MITSUHASHI, Saitama (JP)

(73) Assignee: Tamron Co., Ltd., Saitama (JP)

(21) Appl. No.: 19/649,177

(22) Filed: Apr. 16, 2026

(30) Foreign Application Priority Data
May 8, 2025 (JP) 2025-077999

(51) Int. Cl. G02B 13/00; G02B 3/00; G02B 7/02; G02B 15/14

(52) U.S. Cl. CPC G02B 13/009; G02B 7/025; G02B 13/0045; G02B 13/006; G02B 15/1461; G02B 2003/0093

(57) ABSTRACT

A zoom lens includes, in order from an object side, a positive first lens group, a negative second lens group, a positive third lens group, a negative fourth lens group, a positive fifth lens group, a negative sixth lens group, and a rear group. The first lens group is fixed with respect to an image plane position, and the zoom lens satisfies a specific expression that defines a ratio between an angle of view at a wide-angle end and a lateral magnification of the second lens group at a telephoto end.

### CROSS-REFERENCE TO RELATED APPLICATIONS

This application is based on and claims the benefit of priority from Japanese Patent Application No. 2025-077999, filed on May 8, 2025, the entire contents of which are incorporated herein by reference.

### BACKGROUND OF THE INVENTION

### Technical Field

The present invention relates to a zoom lens and an imaging apparatus.

### Related Art

Conventionally, there are various cameras such as a mirrorless camera, a digital still camera, and a security camera as a camera on which a zoom lens is mounted. In addition, solid-state image sensors mounted on these cameras have been increasing in the number of pixels in recent years. Therefore, the zoom lens mounted on the camera is required to have higher performance than before. As such a zoom lens, there are known a zoom lens having a six-group configuration including a lens group having positive, negative, positive, negative, positive, and negative refractive power in order from the object side (see, for example, JP 2012-032842 A), a zoom lens having a seven-group configuration including a lens group having positive, negative, positive, negative, positive, negative, and positive refractive power in order from the object side (see, for example, JP 2023-099388 A), and the like.

In particular, in a high-magnification zoom lens, there is a demand for high performance that can be used for multipurpose applications. However, in general, in a high-magnification zoom lens, it is difficult to achieve enlargement in the angle of view at the wide-angle end and high performance at the telephoto end. For example, the zoom lens described in JP 2012-032842 A is satisfactory from the viewpoint of high magnification, but the angle of view at the wide-angle end is small, and astigmatism at the telephoto end is not sufficiently corrected. In the zoom lens described in JP 2023-099388 A, aberration correction at the telephoto end is satisfactory, but the zoom magnification is low, and the angle of view at the wide-angle end is also small. As described above, the conventional zoom lens has room for examination from the viewpoint of achieving high magnification, enlargement of the angle of view at the wide-angle end, and high performance at the telephoto end, which enable the zoom lens to be applied to multipurpose applications.

An object of one aspect of the present invention is to provide a zoom lens and an imaging apparatus applicable to multipurpose applications.

### SUMMARY OF THE INVENTION

In order to solve the above problem, a zoom lens according to one aspect of the present invention includes a first lens group having positive refractive power, a second lens group having negative refractive power, a third lens group having positive refractive power, a fourth lens group having negative refractive power, a fifth lens group having positive refractive power, a sixth lens group having negative refractive power, and a rear group, in this order from an object side, in which intervals between adjacent lens groups change at a time of magnification change, the first lens group is fixed with respect to an image plane position, and the following expression is satisfied:

0.2≤|tan(Ww)/β2T|≤2.0 (1)
where
Ww is a maximum half angle of view of the zoom lens at a wide-angle end at a time of infinity focus, and
β2T is a lateral magnification of the second lens group of the zoom lens at a telephoto end at a time of infinity focus.

In order to solve the above problem, an imaging apparatus according to one aspect of the present invention includes the above zoom lens.

According to one aspect of the present invention, it is possible to achieve a zoom lens and an imaging apparatus applicable to multipurpose applications.

### BRIEF DESCRIPTION OF THE DRAWINGS

FIG. 1 is a view schematically illustrating a lens configuration at a wide-angle end and a telephoto end in a zoom lens of Example 1;

FIG. 2 is a view illustrating longitudinal aberrations at each of a wide-angle end, an intermediate focal position, and a telephoto end in the zoom lens of Example 1;

FIG. 3 is a view schematically illustrating a lens configuration at a wide-angle end and a telephoto end in a zoom lens of Example 2;

FIG. 4 is a view illustrating longitudinal aberrations at each of a wide-angle end, an intermediate focal position, and a telephoto end in the zoom lens of Example 2;

FIG. 5 is a view schematically illustrating a lens configuration at a wide-angle end and a telephoto end in a zoom lens of Example 3;

FIG. 6 is a view illustrating longitudinal aberrations at each of a wide-angle end, an intermediate focal position, and a telephoto end in the zoom lens of Example 3;

FIG. 7 is a view schematically illustrating a lens configuration at a wide-angle end and a telephoto end in a zoom lens of Example 4;

FIG. 8 is a view illustrating longitudinal aberrations at each of a wide-angle end, an intermediate focal position, and a telephoto end in the zoom lens of Example 4; and

FIG. 9 is a view schematically illustrating a configuration of an imaging apparatus according to an embodiment of the present invention.

### DESCRIPTION OF THE EMBODIMENTS

Hereinafter, an embodiment of the present invention will be described in detail. In the following description, a “zoom lens” is a general term for optical configurations that exhibit optical characteristics described in the present embodiment, and means one or both of an optical system that exhibits the optical characteristics and an article including the optical system. Note that, in the present specification, the optical characteristics at the wide-angle end or the telephoto end mean the optical characteristics at the wide-angle end or the telephoto end at a time of infinity focus unless otherwise specified. In addition, the “zoom lens” as a general term for the optical configuration is also referred to as an “entire lens system”.

A “lens group” means one lens or a set of two or more lenses. The ordinal number of the lens group means a position from the object side. The lens groups having consecutive ordinal numbers (for example, first and second lens groups) are adjacent to each other in the optical axis direction, and no other lens group is interposed between the lens groups. In a case where one lens group includes a plurality of lenses, it is assumed that the distance on the optical axis between the lenses included in the one lens group does not change at the time of magnification change. In addition, it is assumed that the distance on the optical axis between adjacent lens groups changes at the time of magnification change.

A “lens” may be a single lens or a cemented lens. Examples of single lenses include biconvex lenses, planoconvex lenses, convex meniscus lenses and concave meniscus lenses. The cemented lens has a structure in which two or more single lenses are integrated without an air gap interposed therebetween. The lens may be a spherical lens or an aspherical lens. The aspherical lens may be a composite resin aspherical lens having a configuration in which a composite resin film formed in an aspherical shape is attached to a surface of a glass material.

Furthermore, in the following description, “having positive refractive power” is also simply referred to as “positive”, and “having negative refractive power” is also simply referred to as “negative”.

### [Zoom Lens]

### [Optical Configuration]

The zoom lens according to an embodiment of the present invention includes, in order from an object side, a first lens group having positive refractive power, a second lens group having negative refractive power, and a third lens group having positive refractive power, a fourth lens group having negative refractive power, a fifth lens group having positive refractive power, a sixth lens group having negative refractive power, and a rear group.

A zoom lens having a high magnification has a positive lens group generally arranged on the object side, and changes magnification by mainly moving a second lens group having a strong refractive power. However, in order to correct aberration variation due to magnification change of the second lens group, it is effective to arrange a positive lens group on the image plane side. In a case where the negative lens group is arranged on the image plane side of the second lens group, the aberration generated in the second lens group may not be completely corrected. Therefore, the positive lens group is finally arranged on the image plane side, and this causes an increase in the total length of the zoom lens. Therefore, it is advantageous to include positive, negative, and positive lens groups as a whole from the object side from the viewpoint of obtaining a relatively high zoom magnification in the zoom lens.

In addition, in the present embodiment, it is preferable that the positive lens groups and the negative lens groups be alternately arranged, for example, positive, negative, positive, and negative. Such an arrangement of the lens groups is preferable from the viewpoint of easily canceling the aberration generated in the positive lens group by the negative lens group. From such a viewpoint, it is preferable that the third lens group to the sixth lens group be lens groups having positive, negative, positive, and negative refractive power in order from the object side.

### <First Lens Group>

The first lens group has positive refractive power as a whole. The lens configuration of the first lens group can be appropriately determined in a range of the configuration having positive refractive power as a whole.

The first lens group preferably includes, in order from the object side, a negative lens, a positive lens, and at least one or more positive lenses. It is preferable to make the two lenses on the object side into a negative lens and a positive lens from the viewpoint of being more advantageous in terms of enlargement of the angle of view at the wide-angle end.

In the first lens group, the two object-side lenses, which are a negative lens and a positive lens, are also effective in correcting axial chromatic aberration and lateral chromatic aberration at the telephoto end. From the viewpoint of leading to high performance at the telephoto end, it is preferable that the lenses be joined. As described above, it is preferable that the lens closest to the object side in the first lens group be the cemented lens from the viewpoint of satisfactorily correcting the aberration at the telephoto end.

Furthermore, it is preferable to use the third lens from the object side as a positive lens from the viewpoint of enlargement of the angle of view at the wide-angle end and suppression of distortion involved therewith.

### <Second Lens Group>

The second lens group has negative refractive power as a whole. The lens configuration of the second lens group can be appropriately determined in a range of the configuration having negative refractive power as a whole.

The second lens group preferably includes, in order from the object side, a first negative lens having negative refractive power and a concave surface on the image plane side, and a second negative lens having negative refractive power and a concave surface on the object side. When the angle of view at the wide-angle end is enlarged, the light beam incident angle on the second lens group at the wide-angle end increases. In the configuration such that the second lens group has the two negative lenses arranged in order from the object side, the refractive power of these two negative lenses largely bends the light beam. Therefore, the configuration is preferable from the viewpoint of satisfactorily correcting the field curvature.

Furthermore, it is more preferable that the lens closest to the object side in the second lens group be a composite resin aspherical lens of an aspherical resin layer and a spherical lens from the viewpoint of satisfactorily correcting the field curvature at the wide-angle end.

### <Third Lens Group>

The third lens group has positive refractive power as a whole. The lens configuration of the third lens group can be appropriately determined in a range of the configuration having positive refractive power as a whole.

The third lens group preferably includes a lens in which at least one lens surface is an aspherical surface from the viewpoint of satisfactorily correcting spherical aberration at the wide-angle end.

### <Fourth Lens Group>

The fourth lens group has negative refractive power as a whole. The lens configuration of the fourth lens group can be appropriately determined in a range of the configuration having negative refractive power as a whole.

The fourth lens group preferably includes, in order from the object side, at least one cemented lens of a positive lens and a negative lens, and a vibration-compensation group to be described later. It is preferable that the fourth lens group include the cemented lens from the viewpoint of satisfactorily correcting the axial chromatic aberration at the wide-angle end. In addition, it is preferable that the fourth lens group include the cemented lens on the object side of the vibration-compensation group from the viewpoint of reducing burden on the vibration-compensation group implementing vibration-compensation for suppressing variations in axial chromatic aberration and lateral chromatic aberration.

### <Fifth Lens Group>

The fifth lens group has positive refractive power as a whole. The lens configuration of the fifth lens group can be appropriately determined in a range of the configuration having positive refractive power as a whole.

The fifth lens group preferably includes an aspherical lens in which at least one lens surface is aspherical, and at least one cemented lens of a negative lens and a positive lens. It is preferable that the fifth lens group have the aspherical lens from the viewpoint of satisfactorily correcting spherical aberration particularly at the wide-angle end. In addition, it is preferable that the fifth lens group include the cemented lens from the viewpoint of satisfactorily correcting the axial chromatic aberration and the lateral chromatic aberration particularly at the wide-angle end.

### <Sixth Lens Group>

The sixth lens group has negative refractive power as a whole. The lens configuration of the sixth lens group can be appropriately determined in a range of the configuration having negative refractive power as a whole.

### <Rear Group>

In the present embodiment, the “rear group” includes one or more lens groups. That is, the “rear group” means a set of the seventh lens group and the lens groups located closer to the image plane side than the seventh lens group. The number of lens groups in the rear group may be appropriately determined in a range in which an optical effect by the lens groups can be obtained, and is preferably smaller from the viewpoint of miniaturizing the zoom lens. From such a viewpoint, the number of lens groups in the rear group is preferably two or less (the seventh lens group and the eighth lens group), and more preferably one (only the seventh lens group).

The refractive power of the lens groups constituting the rear group can be appropriately determined in a range in which the effect of the present invention can be obtained. For example, the rear group having positive refractive power as a whole can set the imaging position on the image plane side to a position close to the rear group. This is therefore preferable from the viewpoint of shortening the total optical length. Alternatively, the rear group having negative refractive power as a whole increases the light emission angle from the rear group to the image plane. This is preferable from the viewpoint of reducing the diameter of the rear group itself.

### <Vibration-Compensation Group>

The vibration-compensation group is fixed with respect to the image plane position in the optical axis direction, and can include a lens group configured to be movable in a direction intersecting the optical axis. The vibration-compensation group, which is included in any one of the lens groups described above, is advantageous for the housing that holds the zoom lens to have a simple configuration in mechanism. This is preferable from the viewpoint of simplifying the vibration-compensation structure. More preferably, the vibration-compensation group is included in the lens group fixed with respect to the image plane position. From such a viewpoint, when the fourth lens group is fixed with respect to the image plane position, the vibration-compensation group is preferably arranged in the fourth lens group.

It is preferable that the vibration-compensation group be constituted of a cemented lens of a positive lens and a negative lens from the viewpoint of suppressing variations in axial chromatic aberration and lateral chromatic aberration involved with vibration-compensation. In addition, a cemented lens having negative refractive power is generally more advantageous than a cemented lens having positive refractive power from the viewpoint of weight reduction. Therefore, it is preferable that the cemented lens in the vibration-compensation group have negative refractive power from the viewpoint of suppressing the variation in aberration, the viewpoint of weight reduction, and the viewpoint of simplifying the vibration-compensation structure.

Furthermore, it is preferable that the vibration-compensation group having negative refractive power be arranged between the third lens group having positive refractive power and the fifth lens group having positive refractive power (for example, in the fourth lens group) from the viewpoint of obtaining a satisfactory vibration-compensation effect in which variation in aberration involved with vibration-compensation is suppressed.

### <Focus Group>

The focus group is a lens group that is arranged to be movable in the optical axis direction and moves in the optical axis direction at a time of focusing. The focus group may be any one of the lens groups described above. A more convergent light flux enters the lens group arranged relatively on the image plane side, and the lens diameter can be further reduced. Therefore, it is preferable to set the lens group arranged relatively on the image plane side as the focus group from the viewpoint of suppressing the variation in the angle of view involved with the movement of the focus group and from the viewpoint of moving the focus group quickly at a time of focusing and with a low drive load.

From the same viewpoint as the vibration-compensation group, the focus group preferably includes a cemented lens of a positive lens and a negative lens, and preferably has negative refractive power as a whole.

### <Aperture Stop>

The aperture stop can be appropriately arranged in a range in which the effect of the present invention can be obtained. For example, it is preferable that the aperture stop be arranged between the third lens group and the fourth lens group from the viewpoint of reducing the diameter of the aperture stop because the positive third lens group can mainly converge the on-axis light flux at the wide-angle end. In addition, the aperture stop is preferably arranged integrally with the third lens group from the viewpoint of suppressing occurrence of flare in the entire zoom range.

### [Operation]

### <Magnification Change>

In the zoom lens, intervals between adjacent lens groups change at a time of magnification change. For example, in a zoom lens, magnification change from a wide-angle end to a telephoto end is enabled by changing an air interval on the optical axis between adjacent lens groups. In the present embodiment, the first lens group may be fixed with respect to the image plane position. In the present embodiment, “fixed with respect to the image plane position” means that it is arranged so as not to move in the optical axis direction (fixed in the optical axis direction). It is preferable that the first lens group be fixed with respect to the image plane position from the viewpoint of dust prevention and from the viewpoint of suppressing a variation in the position of the center of gravity involved with magnification change.

In the present embodiment, the fourth lens group may be fixed with respect to the image plane position. The fourth lens group fixed with respect to the image plane position suitably causes the fourth lens group to serve as a reference for a magnification change operation of the lens groups in the entire lens system. This is preferable from the viewpoint of stabilizing the optical performance of the zoom lens at a time of manufacturing.

Furthermore, in the present embodiment, the final lens group in the rear group may be fixed with respect to the image plane position. It is preferable that the final lens group be fixed with respect to the image plane position from the viewpoint of minimizing the housing in the vicinity of the image plane.

Note that, in the zoom lens, the fact that the first lens group and the final lens group are fixed with respect to the image plane position makes the total length of the zoom lens constant, and this is therefore preferable from the viewpoint of making the zoom lens compact.

In addition, in the present embodiment, it is preferable that at least two lens groups closer to the image plane side than the second lens group be configured to move at a time of magnification change from the viewpoint of reducing the amount of movement of the second lens group for magnification change. In addition, the above configuration is preferable from the viewpoint of suppressing aberration variation due to magnification change of the second lens group to exhibit satisfactory optical performance and thereby providing a high-performance compact zoom lens.

In addition, in the present embodiment, it is preferable that the third lens group move on a path having a convex shape toward the object side at a time of magnification change from the wide-angle end to the telephoto end. It is preferable that the third lens group move on the path at a time of magnification change from the viewpoint of satisfactorily correcting the field curvature in the entire zoom range. In addition, the third lens group moving on the path at a time of magnification change makes it possible to further reduce the amount of movement of the second lens group involved with magnification change from the wide-angle end to the telephoto end. This is preferable from the viewpoint of miniaturizing the zoom lens.

### <Focusing>

In the zoom lens according to the present embodiment, focusing can be achieved by moving any of lens groups in the optical axis direction. In addition, the focus group, which is formed of only one lens group, enables simplification of the drive mechanism of the focus group, and this is preferable from the viewpoint of achieving miniaturization and weight reduction of the zoom lens. From such a viewpoint, in the present embodiment, the focus group is preferably the sixth lens group.

### [Optical Characteristics]

The zoom lens according to the present embodiment preferably satisfies at least one of the following expressions from the viewpoint of providing a zoom lens and an imaging apparatus applicable to multipurpose applications.

<Expression (1)>

0.25|tan(Ww)/β2T|≤2.0 (1)
where
Ww is a maximum half angle of view of the zoom lens at the wide-angle end at a time of infinity focus, and
β2T is a lateral magnification of the second lens group at the telephoto end of the zoom lens at a time of infinity focus.

Expression (1) defines the ratio between the angle of view at the wide-angle end of the zoom lens and the lateral magnification of the second lens group at the telephoto end. It is preferable that the zoom lens satisfies Expression (1) from the viewpoint of achieving both the angle of view at the wide-angle end and the optical performance at the telephoto end.

If |tan (Ww)/β2T| is less than 0.2, the optical performance at the telephoto end may be excessive, and it may be difficult to maintain the angle of view at the wide-angle end. In addition, if |tan (Ww)/β2T| exceeds 2.0, it is advantageous for enlarging the angle of view at the wide-angle end, but it may be difficult to maintain optical performance at the telephoto end.

From the viewpoint of achieving both the angle of view at the wide-angle end and the optical performance at the telephoto end, |tan (Ww)/β2T| is more preferably 0.4 or more, still more preferably 0.6 or more, and is more preferably 1.8 or less, still more preferably 1.7 or less.

<Expression (2)>

0.1≤|β3W/β3T|β5.0 (2)
where
β3W is a lateral magnification of the third lens group at the wide-angle end at a time of infinity focus, and
β3T is a lateral magnification of the third lens group at the telephoto end at a time of infinity focus.

Expression (2) defines a ratio between the lateral magnification at the wide-angle end of the third lens group and the lateral magnification at the telephoto end of the third lens group. It is preferable that the zoom lens satisfy Expression (2) from the viewpoint of balancing the field curvature at the wide-angle end and the field curvature at the telephoto end.

If |β3W/β3T| is less than 0.1, aberration suppression of field curvature at the telephoto end may be excessive, and it may be difficult to maintain optical performance at the telephoto end. If |β3W/β3T| exceeds 5.0, aberration suppression of field curvature at the wide-angle end may be excessive, and it may be difficult to maintain optical performance at the wide-angle end.

From the viewpoint of balancing the field curvature at the wide-angle end and the field curvature at the telephoto end, |β3W/β3T| is more preferably 0.12 or more, still more preferably 0.15 or more, and is more preferably 4.7 or less, still more preferably 4.5 or less.

<Expression (3)>

2.0≤DG4/fw≤6.0 (3)
where
DG4 is distance on the optical axis from the image-plane-side surface of the first lens group to the object-side surface of the fourth lens group, and
fw is a focal length of the zoom lens at the wide-angle end at a time of infinity focus.

Expression (3) defines the ratio between the focal length at the wide-angle end and the distance on the optical axis from the image-plane-side surface of the first lens group to the object-side surface of the fourth lens group. The “image-plane-side surface of the first lens group” is a lens surface on the image plane side of a lens closest to the image plane side in the first lens group, and the “object-side surface of the fourth lens group” is a lens surface on the object side of a lens closest to the object side in the fourth lens group. It is preferable that the zoom lens satisfy Expression (3) from the viewpoint of miniaturizing the zoom lens and further angle-widening of the focal length at the wide-angle end.

If DG4/fw is less than 2.0, it is easy to miniaturize the zoom lens, but it may be difficult for the focal length at the wide-angle end to widen the angle. If DG4/fw exceeds 6.0, it is easy for the focal length at the wide-angle end to further widen the angle, but it may be difficult to miniaturize the zoom lens.

From the viewpoint of miniaturizing the zoom lens and further angle-widening of the focal length at the wide-angle end, DG4/fw is more preferably 2.5 or more, still more preferably 3.0 or more, and more preferably 5.5 or less, still more preferably 5.0 or less.

<Expression (4)>

0.4≤f2n/f2≤1.3 (4)
where
f2n is a combined focal length of the first negative lens and the second negative lens, and
f2 is a focal length of the second lens group.

Expression (4) defines a ratio between the focal length of the second lens group and the combined focal length of the negative lens (first negative lens) having the concave surface facing the image plane side and the negative lens (second negative lens) having the concave surface facing the object side of the second lens group. It is preferable that the zoom lens satisfy Expression (4) from the viewpoint of enlarging the angle of view at the wide-angle end and from the viewpoint of satisfactorily correcting the field curvature.

If f2n/f2 is less than 0.4, it is advantageous for enlarging the angle of view at the wide-angle end, but correction of field curvature is excessive at the wide-angle end, and it may be difficult to maintain optical performance at the wide-angle end. If f2n/f2 exceeds 1.3, it is advantageous for satisfactory correction of the field curvature at the wide-angle end, but it may be difficult to enlarge the angle of view at the wide-angle end.

From the viewpoint of enlarging the angle of view at the wide-angle end and satisfactorily correcting the field curvature, f2n/f2 is more preferably 0.5 or more, still more preferably 0.6 or more, and more preferably 1.1 or less, still more preferably 1.0 or less.

<Expression (5)>

1.0≤f1/fw≤10.0 (5)
where
f1 is a focal length of the first lens group, and
fw is a focal length of the zoom lens at the wide-angle end at a time of infinity focus.

Expression (5) defines a ratio between the focal length of the first lens group and the focal length at the wide-angle end. It is preferable that the zoom lens satisfy Expression (5) from the viewpoint of enlargement of the angle of view at the wide-angle end and satisfactory correction of the spherical aberration at the telephoto end.

If f1/fw is less than 1.0, it is advantageous for satisfactory correction of spherical aberration at the telephoto end, but it may be difficult to enlarge the angle of view at the wide-angle end. If f1/fw exceeds 10.0, it is advantageous for enlargement of the angle of view at the wide-angle end, but the spherical aberration at the telephoto end is not sufficiently corrected, and it may be difficult to maintain optical performance.

From the viewpoint of enlargement of the angle of view at the wide-angle end and the viewpoint of satisfactory correction of the spherical aberration at the telephoto end, f1/fw is more preferably 3.0 or more, still more preferably 5.0 or more, and more preferably 8.0 or less, still more preferably 7.0 or less.

<Expression (6)>

2.0≤f4/f2≤30.0 (6)
where
f2 is a focal length of the second lens group, and
f4 is a focal length of the fourth lens group.

Expression (6) defines a ratio between the focal length of the second lens group and the focal length of the fourth lens group. It is preferable that the zoom lens satisfy Expression (6) from the viewpoint of satisfactorily correcting spherical aberration and field curvature at the wide-angle end.

If f4/f2 is less than 2.0, the spherical aberration at the wide-angle end is easily corrected, but the field curvature at the wide-angle end is not sufficiently corrected, and it may be difficult to maintain optical performance. If f4/f2 exceeds 30.0, the field curvature at the wide-angle end is easily corrected, but spherical aberration at the wide-angle end is not sufficiently corrected, and it may be difficult to maintain optical performance.

From the viewpoint of satisfactorily correcting the spherical aberration and the field curvature at the wide-angle end, f4/f2 is more preferably 3.0 or more, still more preferably 5.0 or more, and more preferably 28.0 or less, still more preferably 27.0 or less.

<Expression (7)>

1.0|f5/f2|≤5.0 (7)
where
f2 is a focal length of the second lens group, and
f5 is a focal length of the fifth lens group.

Expression (7) defines a ratio between the focal length of the second lens group and the focal length of the fifth lens group. It is preferable that the zoom lens satisfy Expression (7) from the viewpoint of making satisfactory balance between the amount of movement of the second lens group and the amount of movement of the fifth lens group involved with magnification change.

If |f5/f2| is less than 1.0, the power (refractive power) of the second lens group is weak, so that the amount of movement of the second lens group increases, and the power of the fifth lens group is too strong, so that the amount of movement of the fifth lens group decreases. As a result, the spherical aberration at the wide-angle end is not sufficiently corrected, and it may be difficult to maintain the optical performance. If |f5/f2| exceeds 5.0, the amount of movement of the second lens group decreases, but the power of the fifth lens group is weak, so that the movement amount of the fifth lens group increases. As a result, the field curvature in the entire zoom region may be insufficiently corrected, and it may be difficult to maintain the optical performance.

From the viewpoint of making satisfactory balance between the amount of movement of the second lens group and the amount of movement of the fifth lens group involved with magnification change, |f5/f2| is more preferably 1.5 or more, still more preferably 1.8 or more, and more preferably 4.0 or less, still more preferably 2.5 or less.

<Expression (8)>

0.5≤f6/f2≤6.0 (8)
where
f2 is a focal length of the second lens group, and
f6 is a focal length of the sixth lens group.

Expression (8) defines a ratio between the focal length of the second lens group and the focal length of the sixth lens group. It is preferable that the zoom lens satisfy Expression (8) from the viewpoint of satisfactorily implementing aberration correction at the wide-angle end.

If f6/f2 is less than 0.5, the spherical aberration at the wide-angle end is easily corrected, but the spherical aberration at the wide-angle end is excessively corrected, and it may be difficult to maintain the optical performance at the wide-angle end. If f6/f2 exceeds 6.0, the field curvature at the wide-angle end is easily corrected, but the spherical aberration at the wide-angle end is excessively corrected, and it may be difficult to maintain optical performance at the wide-angle end.

From the viewpoint of satisfactorily implementing aberration correction at the wide-angle end, f6/f2 is more preferably 1.0 or more, still more preferably 1.5 or more, and more preferably 5.0 or less, still more preferably 4.0 or less.

<Expression (9)>

0.55|(1−βvc)×βr|≤2.5 (9)
where
βr is a lateral magnification of all lens groups located closer to the image plane side than the vibration-compensation group at telephoto ends at a time of infinity focus, and
βvc is a lateral magnification of the vibration-compensation group at the telephoto end at a time of infinity focus.

Expression (9) defines the magnification of the vibration-compensation group at the telephoto end. “All lens groups located closer to the image plane side than the vibration-compensation group” means all lens groups located closer to the image plane side than the vibration-compensation group or the lens group including the vibration-compensation group. For example, when the vibration-compensation group is included in the fourth lens group, “all lens groups located closer to the image plane side than the vibration-compensation group” means the fifth lens group and a lens group closer to the image plane than the fifth lens group (that is, the fifth lens group, the sixth lens group, and the rear group). It is preferable that the zoom lens satisfy Expression (9) from the viewpoint of satisfactorily suppressing aberration variation due to vibration-compensation at the telephoto end.

If |(1−βvc)×βr| is less than 0.5, it is easy to reduce the aberration variation due to the vibration-compensation group, but the correction amount increases, and it may be difficult to satisfy desired characteristics of the vibration-compensation group in mechanism. If |(1−βVc)×βr| exceeds 2.5, it is easy to reduce the correction amount of vibration-compensation, but aberration variation due to vibration-compensation increases, and it may be difficult to maintain optical performance.

From the viewpoint of satisfactorily suppressing aberration variation due to vibration-compensation at the telephoto end, |(1−βvc)×βr| is more preferably 0.8 or more, still more preferably 1.1 or more, and is more preferably 2.0 or less, still more preferably 1.5 or less.

### [Imaging Apparatus]

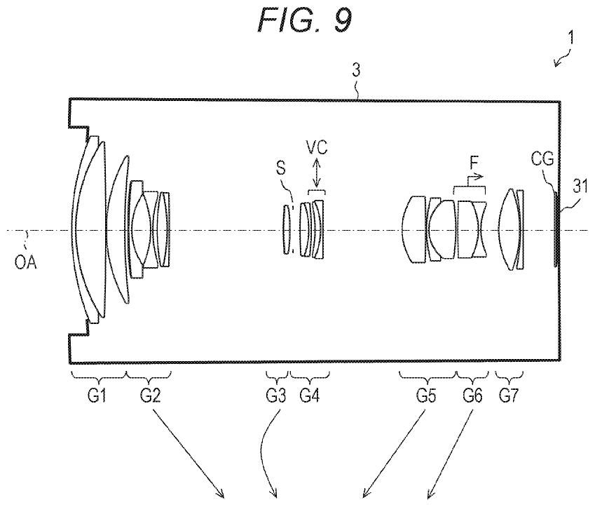

An imaging apparatus according to an embodiment of the present invention includes the zoom lens according to the present embodiment described above. FIG. 9 schematically illustrates a configuration of the imaging apparatus according to the present embodiment. As illustrated in FIG. 9, the imaging apparatus 1 includes a lens barrel 3. The imaging apparatus 1 is, for example, a mirrorless camera.

The lens barrel 3 is, for example, a member having a bottomed cylindrical shape, and has an image sensor 31 and a cover glass CG at the bottom thereof. The image sensor 31 is an element configured to convert an optical image into an electrical signal, and is, for example, a solid-state image sensor. Examples of the solid-state image sensor include a charge coupled device (CCD) sensor and a complementary metal-oxide semiconductor (CMOS) sensor.

The lens barrel 3 includes a first lens group G1, a second lens group G2, a third lens group G3, a fourth lens group G4, a fifth lens group G5, a sixth lens group G6, and a seventh lens group G7 in this order on an optical axis OA. Note that the optical axis OA is an optical axis common to the lens groups and the image sensor 31 of the lens barrel 3.

The first lens group G1 includes a cemented lens of a concave meniscus lens convex toward the object side and a biconvex lens, and a convex meniscus lens convex toward the object side.

The second lens group G2 includes a composite resin aspherical lens having an aspherical resin layer on an object-side surface of a concave meniscus lens convex toward the object side, a biconcave lens, and a cemented lens of a biconvex lens and a concave meniscus lens convex toward the image plane side.

The third lens group G3 includes an aspherical lens convex toward both sides.

The fourth lens group G4 includes a cemented lens of a biconvex lens and a concave meniscus lens convex toward the image plane side, and a cemented lens of a convex meniscus lens convex toward the image plane side and a concave meniscus lens convex toward the image plane side.

The fifth lens group G5 includes an aspherical lens convex toward both sides and a cemented lens of a concave meniscus lens convex toward the object side and a biconvex lens.

The sixth lens group G6 includes a cemented lens of a biconvex lens and a biconcave lens.

The seventh lens group G7 includes an aspherical lens convex toward both sides and a concave meniscus lens convex toward the image plane side.

Arrows on the lower side of the figure each schematically indicate the shape of the path of the lens group in the magnification change from the wide-angle end to the telephoto end. The first lens group G1, the fourth lens group G4, and the seventh lens group G7 are fixed with respect to the image plane position.

Aperture stop S is arranged in the third lens group G3, the fourth lens group G4 includes a vibration-compensation group VC, and the sixth lens group G6 is a focus group F. The first lens group G1 to seventh lens group G7 satisfy at least one of Expressions (1) to (9) described above. That is, the first lens group G1 to seventh lens group G7 correspond to the zoom lens according to the present embodiment described above.

Since the imaging apparatus 1 includes the zoom lens of the present embodiment described above, the imaging apparatus 1 can achieve high magnification, enlargement of the angle of view at the wide-angle end, and high performance at the telephoto end, and thus, is applicable to multipurpose applications. Therefore, the imaging apparatus 1 can be various devices such as a security camera, a digital still camera, a camcorder, or a medical camera in addition to the mirrorless camera.

Note that the imaging apparatus according to the embodiment of the present invention may include, instead of the image sensor 31, other configurations capable of fixing an image collected by the zoom lens. Examples of such other configurations include a silver salt film.

Furthermore, the imaging apparatus according to the embodiment of the present invention may include further optical elements in the optical configuration described above in a range where the effect of the present invention can be obtained and according to the application of the imaging apparatus. For example, the imaging apparatus may have a parallel flat plate having no substantial refractive power as the further optical element instead of the cover glass CG. Examples of such further optical elements include an infrared cut filters (IRCF).

### SUMMARY

A first aspect of the present invention is a zoom lens including a first lens group (G1) having positive refractive power, a second lens group (G2) having negative refractive power, a third lens group (G3) having positive refractive power, a fourth lens group (G4) having negative refractive power, a fifth lens group (G5) having positive refractive power, a sixth lens group (G6) having negative refractive power, and a rear group (seventh lens group G7), in this order from an object side, in which intervals between adjacent lens groups change at a time of magnification change, the first lens group is fixed with respect to the image plane position, and the above Expression (1) is satisfied. According to the first aspect, there can be achieved a high magnification, an enlarged angle of view at a wide-angle end, and a high performance at a telephoto end in the zoom lens, and there can be provided a zoom lens applicable to multipurpose applications.

According to a second aspect of the present invention, in the first aspect, the fourth lens group is fixed with respect to an image plane position, and the third lens group moves on a path having a convex shape toward the object side at a time of magnification change from a wide-angle end to a telephoto end. The second aspect is more effective from the viewpoint of stabilizing the optical performance of the zoom lens at a time of manufacturing and from the viewpoint of satisfactorily correcting the field curvature in the entire zoom range.

A third aspect of the present invention satisfies the above Expression (2) in the first or second aspect. The third aspect is more effective from the viewpoint of balancing the field curvature at the wide-angle end and the field curvature at the telephoto end.

A fourth aspect of the present invention satisfies the above Expression (3) in any of the first to third aspects. The fourth aspect is more effective from the viewpoint of miniaturizing the zoom lens and the viewpoint of further angle-widening of the focal length at the wide-angle end.

According to a fifth aspect of the present invention, in any one of the first to fourth aspects, the second lens group includes, in order from the object side, a first negative lens having negative refractive power and a concave surface on an image plane side, and a second negative lens having negative refractive power and a concave surface on the object side, and the zoom lens satisfies the above Expression (4). The fifth aspect is more effective from the viewpoint of enlarging the angle of view at the wide-angle end and the viewpoint of satisfactorily correcting the field curvature.

A sixth aspect of the present invention satisfies the above Expression (5) in any of the first to fifth aspects. The sixth aspect is more effective from the viewpoint of enlarging the angle of view at the wide-angle end and the viewpoint of satisfactorily correcting the spherical aberration at the telephoto end.

A seventh aspect of the present invention satisfies the above Expression (6) in any of the first to sixth aspects. The seventh aspect is more effective from the viewpoint of satisfactorily correcting the spherical aberration and the field curvature at the wide-angle end.

An eighth aspect of the present invention satisfies the above Expression (7) in any of the first to seventh aspects. The eighth aspect is more effective from the viewpoint of making satisfactory balance between the amount of movement of the second lens group and the amount of movement of the fifth lens group involved with the magnification change.

A ninth aspect of the present invention satisfies the above Expression (8) in any of the first to eighth aspects. The ninth aspect is more effective from the viewpoint of satisfactorily correcting the aberration correction at the wide-angle end.

According to a tenth aspect of the present invention, in any of the first to ninth aspects, the zoom lens further includes a vibration-compensation group (VC) fixed with respect to the image plane position and arranged in the fourth lens group, and satisfies the above Expression (9). The tenth aspect is more effective from the viewpoint of satisfactorily suppressing the aberration variation due to the vibration-compensation at the telephoto end.

An eleventh aspect of the present invention is an imaging apparatus (1) including the zoom lens according to any of the first to tenth aspects. According to the eleventh aspect, there can be achieved high magnification in the zoom lens, enlargement of the angle of view at the wide-angle end, and high performance at the telephoto end, and there can be provided an imaging apparatus applicable to multipurpose applications.

In the present invention, there are achieved enlargement of the angle of view at the wide-angle end and high performance at the telephoto end in a zoom lens with high magnification. The present invention having such an effect is also expected to contribute to the achievement of, for example, the goal 9 of the Sustainable Development Goals (SDGs) proposed by the United Nations (UN), “industry, innovation and infrastructure.”

The present invention is not limited to the above-described embodiments, and various modifications can be made within the scope of the claims. Embodiments obtained by combining as appropriate technical means disclosed in different embodiments are also included in the technical scope of the present invention.

### EXAMPLES

An example of the present invention will be described below.

In the table in each example, “No.” represents a surface number of the lens, “r” represents a curvature radius of the lens, “d” represents a lens thickness or a lens interval, “Nd” represents a refractive index of the d-line, “vd” represents an Abbe number based on the d-line, and “H” represents an effective radius of the lens. The units of “r”, “d”, “H” and “f” are all mm.

In each table, “*” in the surface number indicates that the surface of the surface number is an aspherical surface, “S” indicates that the surface is an aperture stop, and “D(n)” (n is an integer) represents a variable interval on the optical axis between lens surfaces that changes at a time of magnification change or at a time of focusing. Furthermore, “INF” represents infinity, and “IMG” represents an image plane.

The aspherical surface in each example is defined by the following expression. In the following expression, “c” represents the curvature (1/r), “h” represents the height from the optical axis, “k” represents the conic coefficient, and “A4”, “A6”, “A8”, and “A10” represent the aspherical coefficients of the respective orders.

z=ch²/[1+{1−(1+k)c²h²}^{1/2}]+A4h⁴+A6h⁶+A8h⁸+A10h¹⁰ . . . [Expression]

In the tables in the respective examples, “E±a” represents “×10^{±a}”. Any aspherical coefficient not indicated in the table of aspherical data is “0.00”.

In the tables in the examples, “f” represents the focal length of the entire lens system, “FNO” represents the F value of the entire lens system, and “W” represents the half angle of view (°) of the entire lens system.

In the diagrams of the lens configurations in each example, the upper diagram schematically illustrates the lens configuration at the wide-angle end, the lower diagram schematically illustrates the lens configuration at the telephoto end, and arrows between both the diagrams schematically represent the shapes of the paths of the respective lens groups in magnification change from the wide-angle end to the telephoto end. Arrow F indicates a moving direction of the focus group at a time of focusing, and arrow VC indicates a moving direction of the vibration-compensation group at a time of vibration-compensation. Reference characters G1 to G7 in the diagrams respectively represent a first lens group to a seventh lens group, reference character S represents an aperture stop, reference character CG represents a cover glass, and reference character IMG represents an image plane.

In the longitudinal aberration diagram groups in each example, the upper diagram illustrates a longitudinal aberration diagram group at the wide angle end, the middle diagram illustrates a longitudinal aberration diagram group at the intermediate focal position, and the lower diagram illustrates a longitudinal aberration diagram group at the telephoto end. The longitudinal aberration diagrams illustrates an spherical aberration (mm), an astigmatism (mm), and a distortion (%) in order from the left side. In each spherical aberration diagram, a vertical axis represents an F value (in the diagram, it is indicated by FNO), a solid line represents a characteristic of a d-line, a short broken line represents a characteristic of an F-line, and a long broken line represents a characteristic of a C-line. In each astigmatism diagram, the vertical axis represents an angle of view (indicated by ω in the diagram), the solid line represents a characteristic of a sagittal plane (indicated by X in the diagram), and the broken line represents a characteristic of a meridional plane (indicated by Y in the diagram). In each distortion diagram, the vertical axis represents an angle of view (indicated by ω in the diagram).

### Example 1

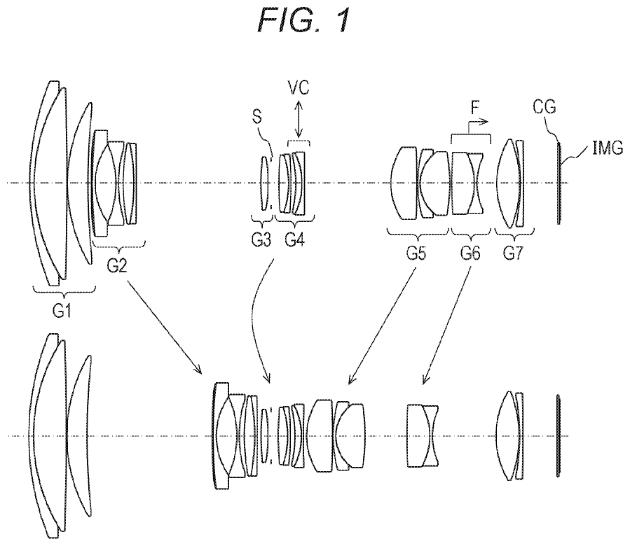

FIG. 1 schematically illustrates an optical configuration of a zoom lens according to Example 1. The zoom lens according to Example 1 includes the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having negative refractive power, and the seventh lens group G7. The seventh lens group G7 has positive refractive power as a whole.

The first lens group G1 includes a cemented lens of a concave meniscus lens convex toward the object side and a biconvex lens, and a convex meniscus lens convex toward the object side.

The second lens group G2 includes a composite resin aspherical lens having an aspherical resin layer on an object-side surface of a concave meniscus lens convex toward the object side, a biconcave lens, and a cemented lens of a biconvex lens and a concave meniscus lens convex toward the image plane side.

The third lens group G3 includes an aspherical lens convex toward both sides.

The fourth lens group G4 includes a cemented lens of a biconvex lens and a concave meniscus lens convex toward the image plane side, and a cemented lens of a convex meniscus lens convex toward the image plane side and a concave meniscus lens convex toward the image plane side.

The fifth lens group G5 includes an aspherical lens convex toward both sides and a cemented lens of a concave meniscus lens convex toward the object side and a biconvex lens.

The sixth lens group G6 includes a cemented lens of a biconvex lens and a biconcave lens.

The seventh lens group G7 includes an aspherical lens convex toward both sides and a concave meniscus lens convex toward the image plane side.

The first lens group G1, the fourth lens group G4, and the seventh lens group G7 are fixed with respect to the image plane position. In the second lens group G2, the “concave meniscus lens convex toward the object side” is a “first negative lens having a concave surface on the image plane side”, and the “biconcave lens” is a “second negative lens having a concave surface on the object side”. The shape of the path between the wide-angle end and the telephoto end at a time of magnification change of third lens group G3 is a shape convex toward the object side. The aperture stop S is arranged in the third lens group G3, and a “cemented lens of a convex meniscus lens convex toward the image plane side and a concave meniscus lens convex toward the image plane side” in the fourth lens group G4 constitutes a vibration-compensation group, and the sixth lens group G6 is a focus group.

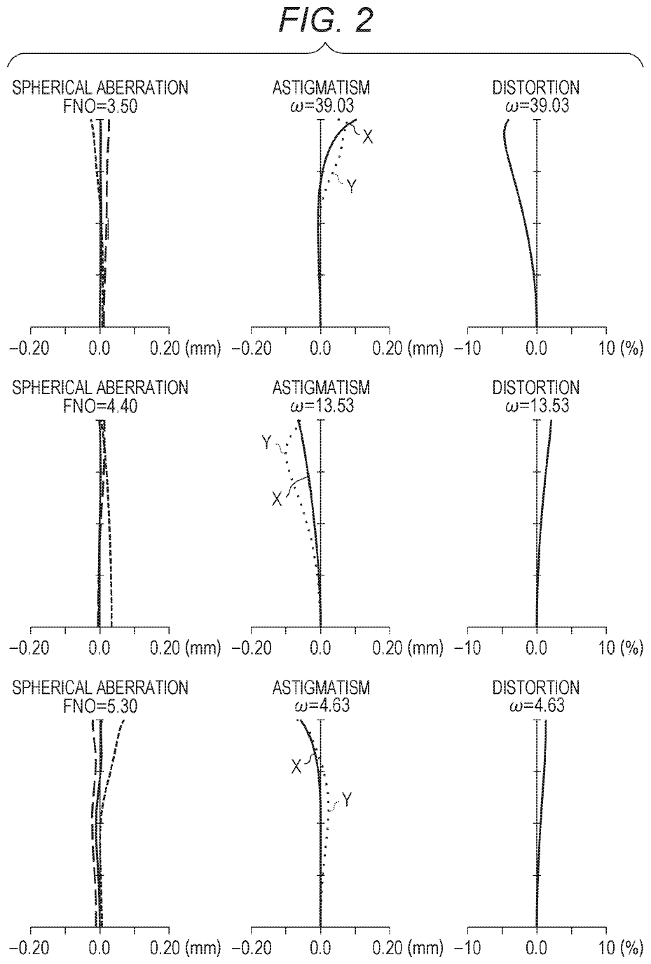

A specification table of the zoom lens of Example 1 is shown in Table 1, aspherical data is shown in Table 2, each variable interval is shown in Table 3, and a focal length of each lens group is shown in Table 4. In addition, each of the longitudinal aberrations at the wide-angle end, the intermediate focal position, and the telephoto end of the zoom lens of Example 1 is illustrated in FIG. 2.

TABLE 1
Specification table

| No. | r | d | Nd | vd | H |
|---|---|---|---|---|---|
| 1 | 78.6471 | 1.3000 | 2.00100 | 29.13 | 28.10 |
| 2 | 51.6507 | 9.5105 | 1.49700 | 81.61 | 26.23 |
| 3 | −879.8540 | 0.1500 | | 26.00 | |
| 4 | 46.4706 | 5.9182 | 1.59282 | 68.62 | 22.00 |
| 5 | 207.3752 | D(5) | | 21.84 | |
| 6* | 1500.0000 | 0.2000 | 1.53610 | 41.21 | 14.43 |
| 7 | 152.8850 | 0.9000 | 1.80420 | 46.50 | 14.28 |
| 8 | 19.6681 | 5.9802 | | 11.23 | |
| 9 | −27.9933 | 0.7500 | 1.90043 | 37.37 | 11.08 |
| 10 | 36.3490 | 1.3936 | | 10.64 | |
| 11 | 60.9504 | 3.0453 | 1.94595 | 17.98 | 10.70 |
| 12 | −58.4378 | 0.7500 | 1.49700 | 81.61 | 10.68 |
| 13 | −822.5608 | D(13) | | 10.52 | |
| 14* | 60.4355 | 2.0120 | 1.61881 | 63.85 | 6.93 |
| 15* | −66.0382 | 1.0000 | | 6.98 | |
| 16S | INF | D(16) | | 6.27 | |
| 17 | 93.6186 | 2.8452 | 1.77250 | 49.62 | 7.43 |
| 18 | −25.1928 | 0.7000 | 2.00069 | 25.46 | 7.55 |
| 19 | −83.6796 | 1.3160 | | 7.73 | |
| 20 | −35.6912 | 1.7745 | 2.00069 | 25.46 | 7.83 |
| 21 | −21.1296 | 0.7000 | 1.71300 | 53.94 | 8.02 |
| 22 | 832.6723 | D(22) | | 8.36 | |
| 23* | 17.9886 | 7.5829 | 1.59201 | 67.02 | 9.50 |
| 24* | −166.2336 | 0.1500 | | 9.24 | |
| 25 | 35.4250 | 0.8000 | 1.83400 | 37.34 | 9.03 |
| 26 | 11.3959 | 8.5575 | 1.49700 | 81.61 | 8.39 |
| 27 | −56.4387 | D(27) | | 8.35 | |
| 28 | 198.7157 | 6.5560 | 1.86966 | 20.02 | 8.20 |
| 29 | −18.5555 | 0.8000 | 1.91082 | 35.25 | 7.88 |
| 30 | 18.2963 | D(30) | | 7.63 | |
| 31* | 25.6507 | 6.6429 | 1.55332 | 71.68 | 11.82 |
| 32* | −35.4762 | 0.2000 | | 11.76 | |
| 33 | −57.8853 | 0.9000 | 2.00272 | 19.32 | 11.48 |
| 34 | −1000.0000 | 10.0000 | | 11.43 | |
| 35 | INF | 0.5000 | 1.51633 | 64.14 | 10.86 |
| 36 | INF | 0.2510 | | 10.83 | |
| IMG | | | | 10.83 | |

TABLE 2
Aspherical data

| No. | k | A4 | A6 | A8 | A10 |
|---|---|---|---|---|---|
| 6 | 0.00000E+00 | 1.54574E−05 | −4.17583E−09 | −8.14040E−11 | 4.32806E−13 |
| 14 | −2.02707E+01 | −1.08169E−05 | −2.86362E−07 | 1.54786E−09 | −9.41858E−11 |
| 15 | 0.00000E+00 | −2.42202E−05 | −2.79358E−07 | 1.84700E−09 | −9.13107E−11 |
| 23 | −3.03233E−01 | −3.73630E−06 | −1.73451E−08 | 2.59231E−10 | −4.90201E−12 |
| 24 | 6.11006E+01 | 1.78500E−05 | −3.65264E−08 | −1.48199E−10 | −4.80226E−12 |
| 31 | 0.00000E+00 | 9.04501E−07 | −5.25814E−08 | 7.12060E−10 | −2.44495E−12 |
| 32 | 0.00000E+00 | 3.54146E−06 | −1.14721E−07 | 1.17638E−09 | −3.75444E−12 |

TABLE 3
Variable interval table

| | Wide-angle | Intermediate | Telephoto |
|---|---|---|---|
| | end | focal position | end |
| f | 13.9044 | 44.0298 | 132.0439 |
| FNO | 3.5021 | 4.4024 | 5.3037 |
| W | 39.0306 | 13.5317 | 4.6256 |
| D(5) | 1.0734 | 21.7320 | 36.3679 |
| D(13) | 36.1584 | 13.8704 | 1.0372 |
| D(16) | 2.1733 | 3.8027 | 2.0000 |
| D(22) | 25.1120 | 9.8387 | 0.8000 |
| D(27) | 0.6000 | 5.5326 | 12.1140 |
| D(30) | 5.6883 | 16.0289 | 18.4863 |

TABLE 4
Focal length of each lens group
Lens group Surface number Focal length

| | | |
|---|---|---|
| G1 | 1-5 | 74.6887 |
| G2 | 6-13 | −13.3802 |
| G3 | 14-16 | 51.3076 |
| G4 | 17-22 | −281.1050 |
| G5 | 23-27 | 26.9150 |
| G6 | 28-30 | −21.3767 |
| G7 | 31-34 | 47.5679 |

### Example 2

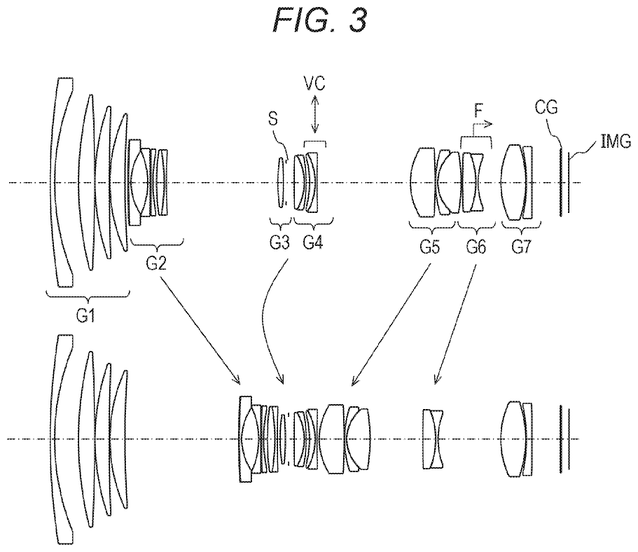

FIG. 3 schematically illustrates an optical configuration of a zoom lens according to Example 2. The zoom lens according to Example 2 includes the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having negative refractive power, and the seventh lens group G7. The seventh lens group G7 has positive refractive power as a whole.

The first lens group G1 includes a concave meniscus lens convex toward the object side, a biconvex lens, and two convex meniscus lenses convex toward the object side.

The second lens group G2 includes a composite resin aspherical lens having an aspherical resin layer on an object-side surface of a concave meniscus lens convex toward the object side, a concave meniscus lens convex toward the image plane side, a concave meniscus lens convex toward the object side, and a cemented lens of a biconvex lens and a biconcave lens.

The third lens group G3 includes an aspherical lens convex toward both sides.

The fourth lens group G4 includes a cemented lens of a biconvex lens and a concave meniscus lens convex toward the image plane side, and a cemented lens of a convex meniscus lens convex toward the image plane side and a concave meniscus lens convex toward the image plane side.

The fifth lens group G5 includes an aspherical lens convex toward both sides and a cemented lens of a concave meniscus lens convex toward the object side and a biconvex lens.

The sixth lens group G6 includes a cemented lens of a biconvex lens and a biconcave lens.

The seventh lens group G7 includes an aspherical lens convex toward both sides and a concave meniscus lens convex toward the image plane side.

The first lens group G1, the fourth lens group G4, and the seventh lens group G7 are fixed with respect to the image plane position. In the second lens group G2, the “concave meniscus lens convex toward the object side” is a “first negative lens having a concave surface on the image plane side”, and the “concave meniscus lens convex toward the image plane side” is a “second negative lens having a concave surface on the object side”. The shape of the path between the wide-angle end and the telephoto end at a time of magnification change of third lens group G3 is a shape convex toward the object side. The aperture stop S is arranged in the third lens group G3, and a “cemented lens of a convex meniscus lens convex toward the image plane side and a concave meniscus lens convex toward the image plane side” in the fourth lens group G4 constitutes a vibration-compensation group, and the sixth lens group G6 is a focus group.

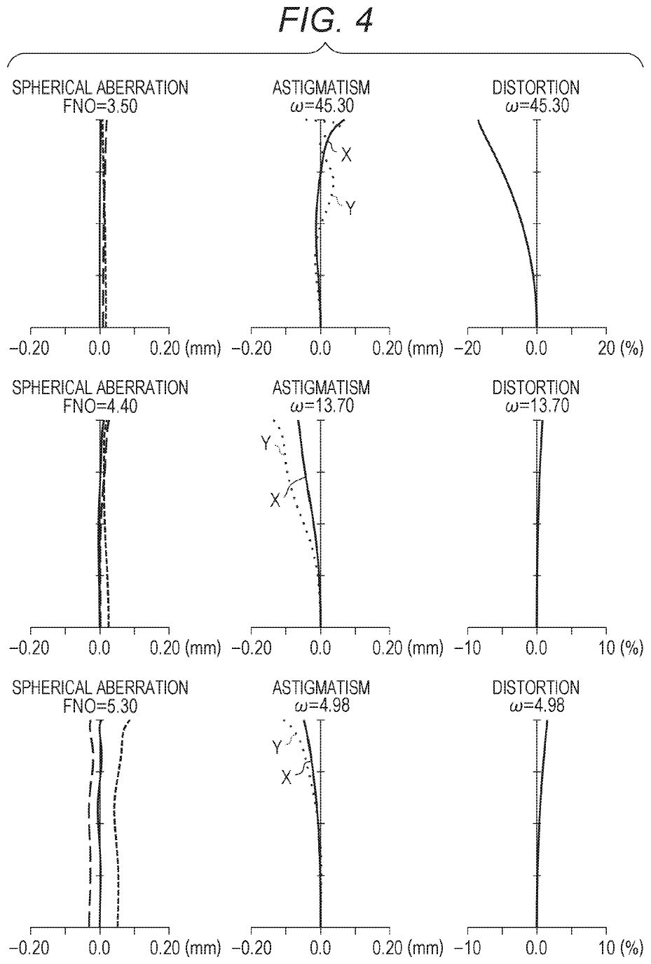

A specification table of the zoom lens of Example 2 is shown in Table 5, aspherical data is shown in Table 6, each variable interval is shown in Table 7, and a focal length of each lens group is shown in Table 8. In addition, each of the longitudinal aberrations at the wide-angle end, the intermediate focal position, and the telephoto end of the zoom lens of Example 2 is illustrated in FIG. 4.

TABLE 5
Specification table

| No. | r | d | Nd | vd | H |
|---|---|---|---|---|---|
| 1 | 238.0747 | 1.5000 | 2.00100 | 29.13 | 35.45 |
| 2 | 86.6801 | 8.5762 | | | 32.85 |
| 3 | 126.4317 | 5.7102 | 1.49700 | 81.61 | 29.61 |
| 4 | −611.1675 | 0.1500 | | | 28.93 |
| 5 | 82.8495 | 5.1037 | 1.49700 | 81.61 | 25.61 |
| 6 | 838.4345 | 0.1500 | | | 25.13 |
| 7 | 58.7283 | 5.4149 | 1.59282 | 68.62 | 23.00 |
| 8 | 358.9186 | D (8) | | | 22.63 |
| 9* | 1132.2927 | 0.2000 | 1.53610 | 41.21 | 14.29 |
| 10 | 280.7782 | 0.9000 | 1.80420 | 46.50 | 14.15 |
| 11 | 20.2650 | 6.0325 | | | 11.25 |
| 12 | −26.2171 | 0.7500 | 1.83400 | 37.34 | 11.13 |
| 13 | −1000.0141 | 0.3000 | | | 10.90 |
| 14 | 706.0884 | 0.7500 | 1.83481 | 42.72 | 10.84 |
| 15 | 58.5788 | 1.3260 | | | 10.70 |
| 16 | 86.8032 | 2.6906 | 1.94595 | 17.98 | 10.70 |
| 17 | −66.0545 | 0.7500 | 1.49700 | 81.61 | 10.68 |
| 18 | 264.0644 | D (18) | | | 10.54 |
| 19* | 59.4950 | 1.9736 | 1.61881 | 63.85 | 7.93 |
| 20* | −87.0949 | 1.0000 | | | 7.96 |
| 21S | INF | D (21) | | | 6.74 |
| 22 | 217.0056 | 3.5126 | 1.77250 | 49.62 | 8.45 |
| 23 | −20.3705 | 0.7000 | 2.00069 | 25.46 | 8.62 |
| 24 | −47.5279 | 1.1543 | | | 8.89 |
| 25 | −37.0232 | 2.0493 | 2.00069 | 25.46 | 9.06 |
| 26 | −21.5289 | 0.7000 | 1.71300 | 53.94 | 9.25 |
| 27 | 239.2239 | D (27) | | | 9.63 |
| 28* | 21.9932 | 8.8858 | 1.59201 | 67.02 | 11.20 |
| 29* | −153.6563 | 0.1500 | | | 10.85 |
| 30 | 37.0191 | 0.8000 | 1.83400 | 37.34 | 10.57 |
| 31 | 13.6874 | 8.2950 | 1.49700 | 81.61 | 9.85 |
| 32 | −65.7830 | D (32) | | | 9.71 |
| 33 | 313.8768 | 4.6744 | 1.86966 | 20.02 | 9.49 |
| 34 | −27.3074 | 0.8000 | 1.91082 | 35.25 | 9.23 |
| 35 | 24.2164 | D (35) | | | 8.90 |
| 36* | 31.3021 | 8.8896 | 1.55332 | 71.68 | 12.35 |
| 37* | −37.0959 | 0.2000 | | | 12.05 |
| 38 | −60.3092 | 2.0000 | 1.98613 | 16.48 | 11.81 |
| 39 | −1000.0000 | 10.0000 | | | 11.72 |
| 40 | INF | 0.5000 | 1.51633 | 64.14 | 11.03 |
| 41 | INF | 2.6690 | | | 11.00 |
| IMG | | | | | 10.83 |

TABLE 6
Aspherical data

| No. | k | A4 | A6 | A8 | A10 |
|---|---|---|---|---|---|
| 9 | 0.00000E+00 | 8.44052E−06 | −1.29856E−08 | 3.58043E−11 | 4.43308E−14 |
| 19 | 1.76628E+00 | 2.11114E−06 | −1.93747E−07 | 2.55274E−09 | −2.03245E−11 |
| 20 | 0.00000E+00 | 2.60079E−06 | −1.96721E−07 | 2.53143E−09 | −2.00545E−11 |
| 28 | −5.16268E−01 | 3.48282E−08 | −8.24974E−09 | 1.28526E−10 | −1.21212E−12 |
| 29 | 6.74378E−01 | 9.15423E−06 | −1.33899E−08 | −1.36444E−11 | −1.13053E−12 |
| 36 | 0.00000E+00 | −4.07484E−06 | 4.99234E−08 | −2.42007E−10 | 1.16745E−12 |
| 37 | 0.00000E+00 | −1.63174E−06 | 6.91881E−08 | −3.15455E−10 | 1.35030E−12 |

TABLE 7
Variable interval table
Wide-angle end Intermediate focal position
Telephoto end

| | | | |
|---|---|---|---|
| f | 12.9013 | 44.0151 | 122.3835 |
| FNO | 3.5010 | 4.4009 | 5.3026 |
| W | 45.2958 | 13.7013 | 4.9766 |
| D (8) | 1.0734 | 25.0185 | 40.6520 |
| D (18) | 39.8670 | 13.5455 | 1.0372 |
| D (21) | 2.7489 | 5.1252 | 2.0000 |
| D (27) | 33.2722 | 10.4169 | 0.8000 |
| D (32) | 0.6000 | 7.0050 | 18.7968 |
| D (35) | 8.1789 | 24.6292 | 22.4543 |

TABLE 8
Focal length of each lens group
Lens group Surface number Focal length

| | | |
|---|---|---|
| G1 | 1-8 | 79.7666 |
| G2 | 9-18 | −14.2252 |
| G3 | 19-21 | 57.4190 |
| G4 | 22-27 | −360.0930 |
| G5 | 28-32 | 29.4432 |
| G6 | 33-35 | −27.7336 |
| G7 | 36-39 | 57.6296 |

### Example 3

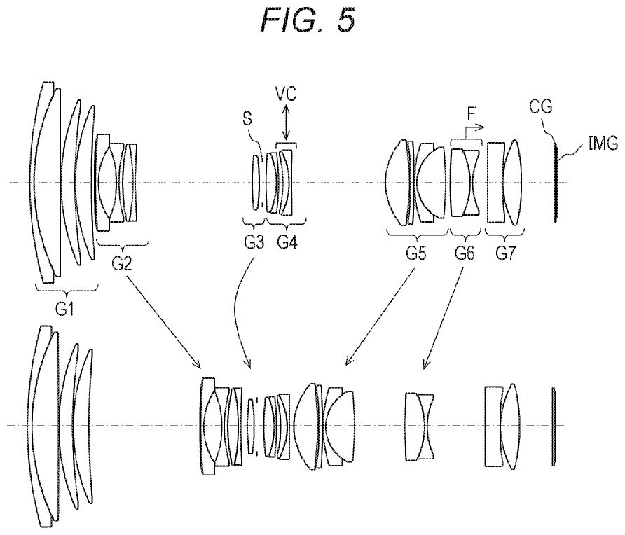

FIG. 5 schematically illustrates an optical configuration of a zoom lens according to Example 3. The zoom lens according to Example 3 includes the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having negative refractive power, and the seventh lens group G7. The seventh lens group G7 has positive refractive power as a whole.

The first lens group G1 includes a cemented lens of a concave meniscus lens convex toward the object side and a biconvex lens, and two convex meniscus lenses convex toward the object side.

The second lens group G2 includes a composite resin aspherical lens having an aspherical resin layer on an object-side surface of a concave meniscus lens convex toward the object side, a biconcave lens, and a cemented lens of a biconvex lens and a biconcave lens.

The third lens group G3 includes an aspherical lens convex toward both sides.

The fourth lens group G4 includes a cemented lens of a biconvex lens and a concave meniscus lens convex toward the image plane side, and a cemented lens of a convex meniscus lens convex toward the image plane side and a concave meniscus lens convex toward the image plane side.

The fifth lens group G5 includes an aspherical lens convex toward both sides, a concave meniscus lens convex toward the image plane side, and a cemented lens of a concave meniscus lens convex toward the object side and a biconvex lens.

The sixth lens group G6 includes a cemented lens of a biconvex lens and a biconcave lens.

The seventh lens group G7 includes a biconcave lens and an aspherical lens convex toward both sides.

The first lens group G1, the fourth lens group G4, and the seventh lens group G7 are fixed with respect to the image plane position. In the second lens group G2, the “concave meniscus lens convex toward the object side” is a “first negative lens having a concave surface on the image plane side”, and the “biconcave lens” is a “second negative lens having a concave surface on the object side”. The shape of the path between the wide-angle end and the telephoto end at a time of magnification change of third lens group G3 is a shape convex toward the object side. The aperture stop S is arranged in the third lens group G3, and a “cemented lens of a convex meniscus lens convex toward the image plane side and a concave meniscus lens convex toward the image plane side” in the fourth lens group G4 constitutes a vibration-compensation group, and the sixth lens group G6 is a focus group.

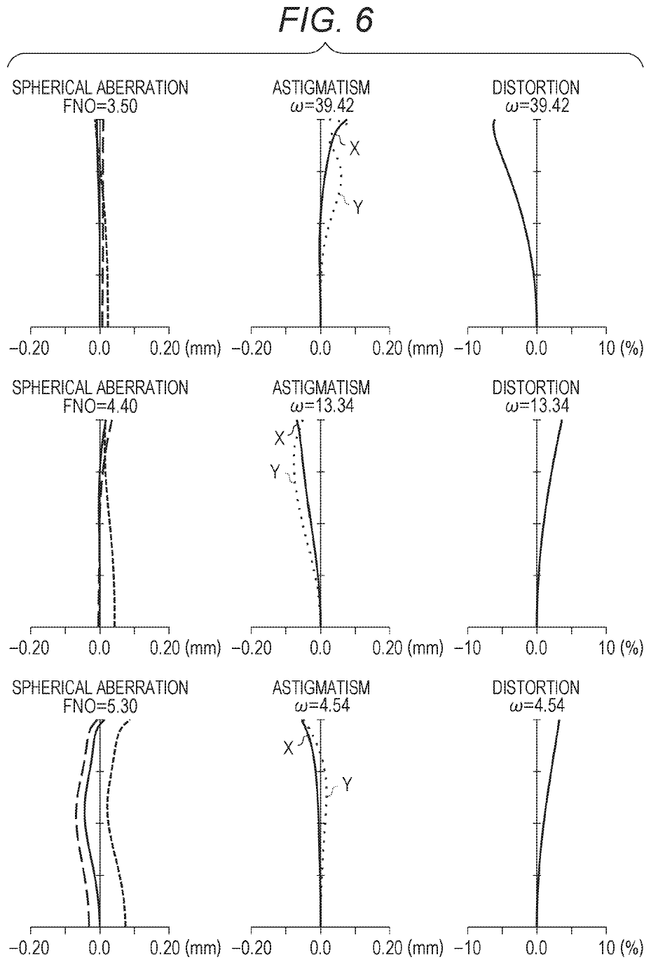

A specification table of the zoom lens of Example 3 is shown in Table 9, aspherical data is shown in Table 10, each variable interval is shown in Table 11, and a focal length of each lens group is shown in Table 12. In addition, each of the longitudinal aberrations at the wide-angle end, the intermediate focal position, and the telephoto end of the zoom lens of Example 3 is illustrated in FIG. 6.

TABLE 9
Specification table

| No. | r | d | Nd | vd | H |
|---|---|---|---|---|---|
| 1 | 115.8200 | 1.3000 | 2.00100 | 29.13 | 28.85 |
| 2 | 63.6224 | 8.0254 | 1.49700 | 81.61 | 27.00 |
| 3 | −5000.0000 | 0.1500 | | | 26.00 |
| 4 | 62.1161 | 4.2454 | 1.49700 | 81.61 | 23.54 |
| 5 | 161.8475 | 0.1500 | | | 23.15 |
| 6 | 57.8216 | 4.7523 | 1.61800 | 63.39 | 22.00 |
| 7 | 245.8773 | D (7) | | | 21.61 |
| 8* | 700.0000 | 0.2000 | 1.53610 | 41.21 | 13.71 |
| 9 | 180.7791 | 0.9000 | 1.80420 | 46.50 | 13.57 |
| 10 | 19.9416 | 5.4907 | | | 10.95 |
| 11 | −28.9026 | 0.7500 | 1.90043 | 37.37 | 10.90 |
| 12 | 37.7389 | 1.1227 | | | 10.60 |
| 13 | 54.2417 | 3.1010 | 1.94595 | 17.98 | 10.70 |
| 14 | −61.7567 | 0.7500 | 1.49700 | 81.61 | 10.65 |
| 15 | 168.3445 | D (15) | | | 10.47 |
| 16* | 60.1596 | 2.0634 | 1.61881 | 63.85 | 7.43 |
| 17* | −76.9869 | 1.0000 | | | 7.48 |
| 18S | INF | D (18) | | | 6.18 |
| 19 | 102.5217 | 3.1042 | 1.77250 | 49.62 | 7.96 |
| 20 | −24.4429 | 0.7000 | 2.00069 | 25.46 | 8.09 |
| 21 | −69.8707 | 1.3110 | | | 8.28 |
| 22 | −34.5634 | 1.9051 | 2.00069 | 25.46 | 8.46 |
| 23 | −20.6616 | 0.7000 | 1.71300 | 53.94 | 8.64 |
| 24 | 677.2170 | D (24) | | | 9.00 |
| 25* | 18.6478 | 7.2675 | 1.59201 | 67.02 | 12.00 |
| 26* | −62.8824 | 0.4171 | | | 11.68 |
| 27 | −81.7142 | 1.0000 | 1.62004 | 36.30 | 11.56 |
| 28 | −190.8330 | 0.1500 | | | 11.38 |
| 29 | 37.5342 | 0.8000 | 1.83400 | 37.34 | 10.89 |
| 30 | 11.9343 | 8.7072 | 1.49700 | 81.61 | 9.76 |
| 31 | −92.4112 | D (31) | | | 9.60 |
| 32 | 127.3219 | 6.0000 | 1.86966 | 20.02 | 9.29 |
| 33 | −22.3729 | 0.8000 | 1.91082 | 35.25 | 8.90 |
| 34 | 20.2356 | D (34) | | | 8.48 |
| 35 | −8581.3156 | 4.4948 | 1.98613 | 16.48 | 10.54 |
| 36 | 81.1777 | 0.1500 | | | 11.05 |
| 37* | 24.8518 | 5.7317 | 1.55332 | 71.68 | 11.83 |
| 38* | −54.0960 | 10.0000 | | | 11.91 |
| 39 | INF | 0.5000 | 1.51633 | 64.14 | 10.89 |
| 40 | INF | 0.2704 | | | 10.86 |
| IMG | | | | | 10.84 |

TABLE 10
Aspherical data

| No. | k | A4 | A6 | A8 | A10 | A12 |
|---|---|---|---|---|---|---|
| 8 | 0.00000E+00 | 1.25853E−05 | −1.26302E−08 | 2.55147E−11 | 1.43394E−13 | 0.00000E+00 |
| 16 | −1.18669E+01 | −5.07786E−06 | −2.05973E−07 | 1.60693E−09 | −4.90815E−11 | 0.00000E+00 |
| 17 | 0.00000E+00 | −1.43312E−05 | −1.89689E−07 | 1.44221E−09 | −4.62721E−11 | 0.00000E+00 |
| 25 | −5.87421E−01 | 1.43598E−06 | 4.26771E−08 | −1.00860E−10 | 2.31050E−13 | 0.00000E+00 |
| 26 | −1.44734E+01 | 8.36927E−06 | 4.26825E−08 | −3.84499E−10 | 1.20846E−12 | −1.76082E−15 |
| 37 | 0.00000E+00 | −2.87051E−06 | −8.67652E−08 | 7.59912E−10 | −3.66977E−12 | 0.00000E+00 |
| 38 | 0.00000E+00 | 1.21321E−05 | −1.49898E−07 | 1.02924E−09 | −4.41656E−12 | 0.00000E+00 |

TABLE 11
Variable interval table
Wide-angle end Intermediate focal
position Telephoto end

| | | | |
|---|---|---|---|
| f | 14.0064 | 44.0184 | 132.0094 |
| FNO | 3.5012 | 4.4012 | 5.3023 |
| W | 39.4238 | 13.3449 | 4.5391 |
| D (7) | 1.0734 | 20.1428 | 33.7272 |
| D (15) | 35.4953 | 14.6766 | 2.0000 |
| D (18) | 1.1585 | 2.9078 | 2.0000 |
| D (24) | 28.3739 | 12.0938 | 1.3000 |
| D (31) | 1.4066 | 6.0458 | 15.3024 |
| D(34) | 4.4690 | 16.1098 | 17.6470 |

TABLE 12
Focal length of each lens group
Lens group Surface number Focal length

| | | |
|---|---|---|
| G1 | 1−7 | 72.3357 |
| G2 | 8−15 | −13.2930 |
| G3 | 16−18 | 54.8893 |
| G4 | 19−24 | −337.7590 |
| G5 | 25−31 | 28.4779 |
| G6 | 32−34 | −25.7080 |
| G7 | 35−38 | 50.2096 |

### Example 4

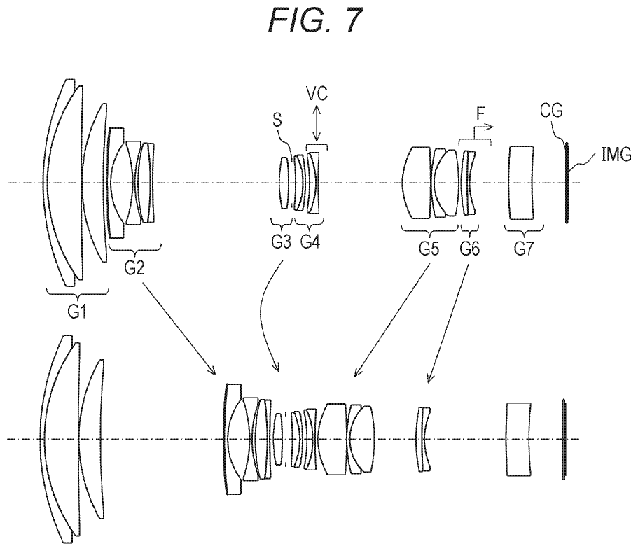

FIG. 7 schematically illustrates an optical configuration of a zoom lens according to Example 4. The zoom lens according to Example 4 includes the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having negative refractive power, and the seventh lens group G7. The seventh lens group G7 has negative refractive power as a whole.

The first lens group G1 includes a cemented lens of a concave meniscus lens convex toward the object side and a convex meniscus lens convex toward the object side, and a convex meniscus lens convex toward the object side.

The second lens group G2 includes a composite resin aspherical lens having an aspherical resin layer on an object-side surface of a concave meniscus lens convex toward the object side, a biconcave lens, and a cemented lens of a biconvex lens and a biconcave lens. lens convex toward both sides.

The fourth lens group G4 includes two cemented lenses each including a convex meniscus lens convex toward the image plane side and a concave meniscus lens convex toward the image plane side.

The fifth lens group G5 includes an aspherical lens convex toward both sides and a cemented lens of a concave meniscus lens convex toward the object side and a biconvex lens.

The sixth lens group G6 includes a cemented lens of a convex meniscus lens convex toward the object side and a concave meniscus lens convex toward the object side.

The seventh lens group G7 includes a concave meniscus lens convex toward the object side.

The first lens group G1, the fourth lens group G4, and the seventh lens group G7 are fixed with respect to the image plane position. In the second lens group G2, the “concave meniscus lens convex toward the object side” is a “first negative lens having a concave surface on the image plane side”, and the “biconcave lens” is a “second negative lens having a concave surface on the object side”. The shape of the path between the wide-angle end and the telephoto end at a time of magnification change of third lens group G3 is a shape convex toward the object side. The aperture stop S is arranged in the third lens group G3, the cemented lens on the image plane side in the fourth lens group G4 constitutes a vibration-compensation group, and the sixth lens group G6 is a focus group.

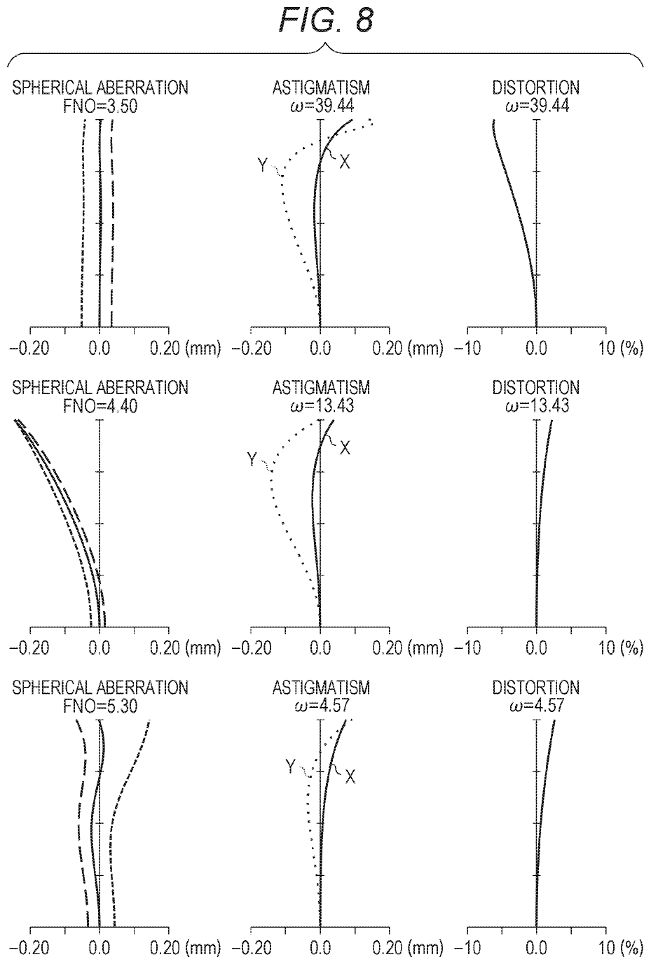

A specification table of the zoom lens of Example 4 is shown in Table 13, aspherical data is shown in Table 14, each variable interval is shown in Table 15, and a focal length of each lens group is shown in Table 16. In addition, each of the longitudinal aberrations at the wide-angle end, the intermediate focal position, and the telephoto end of the zoom lens of Example 4 is illustrated in FIG. 8.

TABLE 13
Specification table

| No. | r | d | Nd | vd | H |
|---|---|---|---|---|---|
| 1 | 71.5501 | 1.3000 | 2.00100 | 29.13 | 28.96 |
| 2 | 48.7806 | 10.0000 | 1.49700 | 81.61 | 26.93 |
| 3 | 943.9154 | 0.1500 | | | 26.00 |
| 4 | 47.7831 | 6.3326 | 1.59282 | 68.62 | 22.00 |
| 5 | 233.2541 | D (5) | | | 21.46 |
| 6* | 700.0000 | 0.2000 | 1.53610 | 41.21 | 15.23 |
| 7 | 169.2931 | 0.9000 | 1.80420 | 46.50 | 15.04 |
| 8 | 20.0336 | 6.4783 | | | 11.85 |
| 9 | −34.9349 | 0.7500 | 1.90043 | 37.37 | 11.26 |
| 10 | 33.8971 | 0.8437 | | | 10.68 |
| 11 | 44.7493 | 3.5765 | 1.94595 | 17.98 | 10.70 |
| 12 | −95.5452 | 0.7500 | 1.49700 | 81.61 | 10.61 |
| 13 | 164.9695 | D (13) | | | 10.43 |
| 14* | 32.6156 | 2.6745 | 1.61881 | 63.85 | 6.91 |
| 15* | −80.4181 | 1.0000 | | | 6.90 |
| 16S | INF | D (16) | | | 6.06 |
| 17 | −78.0231 | 2.1419 | 1.77250 | 49.62 | 7.07 |
| 18 | −20.4197 | 0.7000 | 2.00069 | 25.46 | 7.23 |
| 19 | −42.0624 | 1.2897 | | | 7.45 |
| 20 | −40.1666 | 1.7788 | 2.00069 | 25.46 | 7.74 |
| 21 | −21.8095 | 0.7000 | 1.71300 | 53.94 | 7.91 |
| 22 | 181.3771 | D (22) | | | 8.21 |
| 23* | 19.1064 | 8.4020 | 1.59201 | 67.02 | 9.50 |
| 24* | −168.7585 | 0.1500 | | | 9.33 |
| 25 | 43.8883 | 0.8000 | 1.83400 | 37.34 | 9.23 |
| 26 | 13.1406 | 7.2790 | 1.49700 | 81.61 | 8.78 |
| 27 | −43.8960 | D (27) | | | 8.85 |
| 28 | 45.3482 | 1.7329 | 1.86966 | 20.02 | 8.59 |
| 29 | 177.8418 | 0.8000 | 1.91082 | 35.25 | 8.44 |
| 30 | 21.8310 | D (30) | | | 8.15 |
| 31 | 127.9665 | 6.8574 | 2.00272 | 19.32 | 9.74 |
| 32 | 110.4480 | 10.0000 | | | 9.78 |
| 33 | INF | 0.5000 | 1.51633 | 64.14 | 10.76 |
| 34 | INF | 0.2415 | | | 10.80 |
| IMG | | | | | 10.83 |

TABLE 14
Aspherical data

| No. | k | A4 | A6 | A8 | A10 |
|---|---|---|---|---|---|
| 6 | 0.00000E+00 | 1.00816E−05 | −1.37068E−09 | −1.87637E−11 | 5.86767E−14 |
| 14 | −4.79911E+00 | −4.55105E−07 | −2.54582E−07 | 2.50703E−09 | −8.51957E−11 |
| 15 | 0.00000E+00 | −1.46276E−05 | −2.27698E−07 | 1.97604E−09 | −7.74410E−11 |
| 23 | −3.94800E−01 | −8.70039E−06 | 8.27062E−09 | −3.57085E−10 | −4.52840E−13 |
| 24 | 7.61696E+01 | 1.38542E−05 | 1.06839E−08 | −9.34098E−10 | 1.14297E−12 |

TABLE 15
Variable interval table
Wide-angle end Intermediate focal position
Telephoto end

| | | | |
|---|---|---|---|
| f | 14.0026 | 44.3250 | 132.0511 |
| FNO | 3.5020 | 4.4040 | 5.3067 |
| W | 39.4448 | 13.4263 | 4.5651 |
| D ( 5) | 1.0734 | 20.9996 | 36.4612 |
| D (13) | 37.3581 | 14.0243 | 1.0372 |
| D (16) | 1.0669 | 4.4744 | 2.0000 |
| D (22) | 24.8380 | 9.8366 | 0.8000 |
| D (27) | 0.7211 | 3.8351 | 12.2996 |
| D (30) | 11.4756 | 23.3630 | 23.9351 |

TABLE 16
Focal length of each lens group
Lens group Surface number Focal length

| | | |
|---|---|---|
| G1 | 1−5 | 77.3958 |
| G2 | 6−13 | −13.8096 |
| G3 | 14−16 | 37.8410 |
| G4 | 17−22 | −78.8402 |
| G5 | 23−27 | 27.3776 |
| G6 | 28−30 | −47.0892 |
| G7 | 31−32 | −1000.7200 |

The calculated values of the above-described expressions in Examples 1 to 4 are shown in Table 17. The numerical values in the above-described expressions in Examples 1 to 4 are shown in Table 18.

TABLE 17

| Expression | Conditional | | | | |
|---|---|---|---|---|---|
| No. | Expression | Example 1 | Example 2 | Example 3 | Example 4 |
| 1 | \|tanWw/β2T\| | 0.963 | 1.637 | 1.034 | 1.002 |
| 2 | \|β3W/β3T\| | 1.681 | 2.846 | 4.342 | 0.156 |
| 3 | DG4/fw | 3.987 | 4.679 | 3.791 | 4.047 |
| 4 | f2n/f2 | 0.682 | 0.921 | 0.715 | 0.699 |
| 5 | f1/fw | 5.372 | 6.183 | 5.164 | 5.527 |
| 6 | f4/f2 | 21.009 | 25.314 | 25.409 | 5.709 |
| 7 | \|f5/f2\| | 2.012 | 2.070 | 2.142 | 1.983 |
| 8 | f6/f2 | 1.598 | 1.950 | 1.934 | 3.410 |
| 9 | \|(1-βvc)*βr\| | 1.118 | 1.434 | 1.271 | 1.133 |

TABLE 18

| | Example 1 | Example 2 | Example 3 | Example 4 |
|---|---|---|---|---|
| tanWw | 0.8101 | 1.0096 | 0.8215 | 0.8221 |
| β2T | −0.8410 | −0.6168 | −0.7943 | −0.8204 |
| β3W | −5.0262 | −6.6341 | −11.0586 | −1.5275 |
| β3T | 2.9906 | 2.3312 | 2.5470 | 9.7794 |
| DG4 | 55.4361 | 60.3619 | 53.1049 | 56.6714 |
| fw | 13.9044 | 12.9013 | 14.0064 | 14.0026 |
| f2n | −9.1273 | −13.1070 | −9.5079 | −9.6579 |
| f2 | −13.3802 | −14.2252 | −13.2930 | −13.8096 |
| f1 | 74.6887 | 79.7666 | 72.3357 | 77.3958 |
| f4 | −281.1050 | −360.0930 | −337.7590 | −78.8402 |
| f5 | 26.9150 | 29.4432 | 28.4779 | 27.3776 |
| f6 | −21.3767 | −27.7336 | −25.7080 | −47.0892 |
| βvc | −0.1316 | −0.0814 | −0.0919 | −0.0089 |
| βr | −0.9879 | −1.3264 | −1.1640 | −1.1229 |

What is claimed is:

1. A zoom lens comprising a first lens group having positive refractive power, a second lens group having negative refractive power, a third lens group having positive refractive power, a fourth lens group having negative refractive power, a fifth lens group having positive refractive power, a sixth lens group having negative refractive power, and a rear group, in this order from an object side, wherein
intervals between adjacent lens groups change at a time of magnification change,
the first lens group is fixed with respect to an image plane position, and
the following expression is satisfied:
0.2≤|tan(Ww)/β2T|≤2.0 (1)
where
Ww is a maximum half angle of view of the zoom lens at a wide-angle end at a time of infinity focus, and
β2T is a lateral magnification of the second lens group of the zoom lens at a telephoto end at a time of infinity focus.

2. The zoom lens according to claim 1, wherein
the fourth lens group is fixed with respect to an image plane position, and
the third lens group moves on a path having a convex shape toward the object side at a time of magnification change from a wide-angle end to a telephoto end.

3. The zoom lens according to claim 1, wherein the following expression is satisfied:
0.1≤|β3W/β3T|≤5.0 (2)
where
β3W is a lateral magnification of the third lens group at a wide-angle end at a time of infinity focus, and
β3T is a lateral magnification of the third lens group at a telephoto end at a time of infinity focus.

4. The zoom lens according to claim 1, wherein the following expression is satisfied:
2.0≤DG4/fw≤6.0 (3)
where
DG4 is a distance on an optical axis from an image-plane-side surface of the first lens group to an object-side surface of the fourth lens group, and
fw is a focal length of the zoom lens at a wide-angle end at a time of infinity focus.

5. The zoom lens according to claim 1, wherein
the second lens group includes, in order from the object side, a first negative lens having negative refractive power and a concave surface on an image plane side, and a second negative lens having negative refractive power and a concave surface on the object side, and
the following expression is satisfied:
0.4≤f2n/f2≤1.3 (4)
where
f2n is a combined focal length of the first negative lens and the second negative lens, and
f2 is a focal length of the second lens group.

6. The zoom lens according to claim 1, wherein the following expression is satisfied:
1.0≤f1/fw≤10.0 (5)
where
f1 is a focal length of the first lens group, and
fw is a focal length of the zoom lens at a wide-angle end at a time of infinity focus.

7. The zoom lens according to claim 1, wherein the following expression is satisfied:
2.0≤f4/f2≤30.0 (6)
where
f2 is a focal length of the second lens group, and
f4 is a focal length of the fourth lens group.

8. The zoom lens according to claim 1, wherein the following expression is satisfied:
1.0≤|f5/f2|≤5.0 (7)
where
f2 is a focal length of the second lens group, and
f5 is a focal length of the fifth lens group.

9. The zoom lens according to claim 1, wherein the following expression is satisfied:
0.5≤f6/f2≤6.0 (8)
where
f2 is a focal length of the second lens group, and
f6 is a focal length of the sixth lens group.

10. The zoom lens according to claim 1, further comprising a vibration-compensation group fixed with respect to an image plane position and arranged in the fourth lens group,
wherein the following expression is satisfied:
0.5≤|(1−βvc)×βr|≤2.5 (9)
where
βr is a lateral magnification of all lens groups located closer to an image plane side than the vibration-compensation group at a telephoto end at a time of infinity focus, and
βvc is a lateral magnification of the vibration-compensation group at a telephoto end at a time of infinity focus.

11. An imaging apparatus comprising the zoom lens according to claim 1.
